(19) United States
(12) Patent Application Publication
(10) Pub. No.: US 2003/0091684 A1
(43) Pub. Date: May 15, 2003

(54) Injection nozzle for gum elastic, rubber and polysiloxanes

(75) Inventor: Christian Hefner, Weisskirchen An Der Traun (AT)

Correspondence Address: YOUNG & THOMPSON, 745 SOUTH 23RD STREET 2ND FLOOR, ARLINGTON, VA, 22202

(73) Assignee: HEFNER ELASTOMERE-TECHNIK GMBH, WEISSKIRCHEN AN DER TRAUN (AT)

(21) Appl. No.: 10/119,858

(22) Filed: Apr. 11, 2002

(30) Foreign Application Priority Data
Nov. 14, 2001 (AT) GM 878/2001

(51) Int. Cl. B29C 45/20

(52) U.S. Cl. 425/549; 425/569

(57) ABSTRACT

Injection nozzle (8) for polymers which are not crosslinked, but which can be crosslinked, especially gum elastic, rubber and polysiloxanes discharges with its nozzle tip (15) in the area of the mold cavity (6) at the entry hole (18) which is located in the mold plate (2) and which discharges into a mold cavity (6). In the nozzle (8) there is a nozzle needle (40) which can be moved axially by a linear motor (50) and which can be moved out of the closed position which seals the hole (16) in the nozzle tip (15) and into the open position in which the end of the needle (40) is located at a distance from the tip hole (10) in the nozzle tip (15). The injection nozzle (8) is cooled via a temperature control jacket (13, 14) through which a temperature control liquid flows. In the closed position the end surface (73) of the nozzle needle (40) is flush with the surface (74) of the mold cavity (6) in which the entry hole (18) is located.

The invention relates to an injection nozzle for polymers which are not crosslinked, but which can be crosslinked, especially gum elastic, rubber and polysiloxanes.

Polymers which are not crosslinked, but which can be crosslinked, especially gum elastic, rubber and polysiloxanes and other comparable materials are conventionally injected into mold cavities via distributor channels or spiders, these materials during the injection process having to be kept at a temperature level above room temperature, in that they are liquid enough, but it must be unconditionally avoided that they are heated to overly high temperatures at which they begin to cure since this process cannot be made retroactive.

When the injection process is carried out via distributor spiders and the like, no problems arise since the temperature difference between the mold cavity and the feed channels upstream of the distributor spider can be easily equalized and the material which has only partially cured under certain circumstances in the distributor spider is disposed of anyway as scrap. This on the other hand however represents a disadvantage, since costs are incurred due to this scrap.

Therefore the object of the invention is to make available an injection nozzle in which the aforementioned material which is difficult to handle in terms of temperature can be processed without waste, i.e. without distributor spiders or the like.

This object is achieved as claimed in the invention with an injection nozzle with the features of claim 1.

The combination of a liquid-temperature controlled injection nozzle with a needle seal makes it possible to inject the aforementioned materials directly or through an only quite short entry hole into the mold cavity. The nozzle needle separates the material injected into the mold cavity from the material located in the injection nozzle, the liquid-temperature controlled nozzle tip enabling optimum temperature control of the material which is to be injected and which is exposed to major temperature fluctuations during processing. These temperature fluctuations are caused in part by the material being exposed to high shearing forces during the injection process, especially in the injection nozzle, by which the material could be heated too strongly by internal friction. On the other hand, however, provisions must be made for sufficient heating of the material during the injection process. It is furthermore ensured by liquid temperature control that due to the comparatively long cycle times which can be necessary for curing of the material in the mold cavity, overly strong heating of the material by the bordering mold plate is avoided.

Preferred and advantageous embodiments of the nozzle as claimed in the invention are the subject matter of the dependent claims.

If according to one embodiment of the invention it is provided that the nozzle needle is guided in the nozzle not to be able to turn around its axis, the front end of the nozzle needle can have a geometry (shape of the end surface of the nozzle needle) which is matched for example to the contour of the mold cavity.

The needle seal nozzle as claimed in the invention can be preferably and advantageously used in conjunction with an injection mold. Therefore the invention also applies to an injection mold with (at least) one needle seal injection nozzle as claimed in the invention.

The drive for moving the nozzle needle can be made as desired. Thus, to move the nozzle needle a hydraulic cylinder (gas- or liquid-supplied), magnetic drives or cam drives can be used.

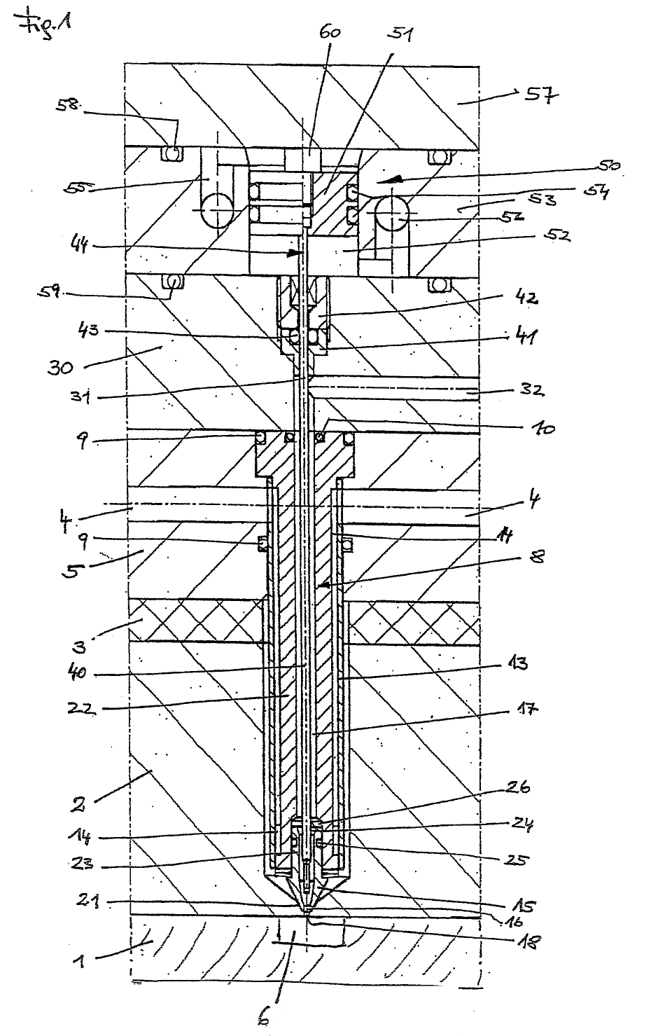

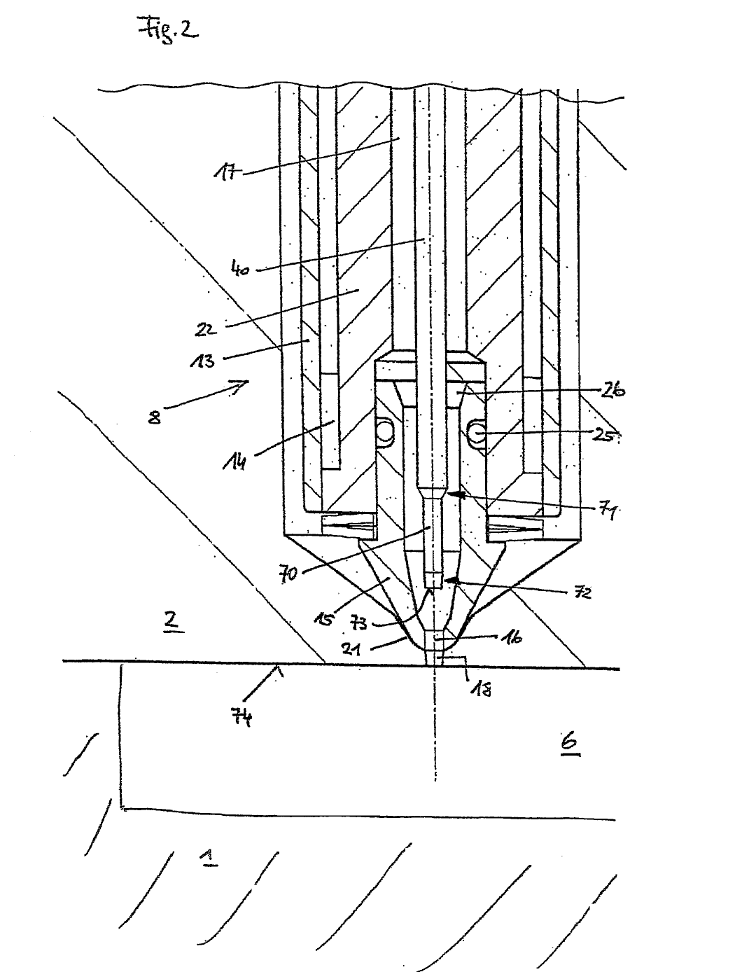

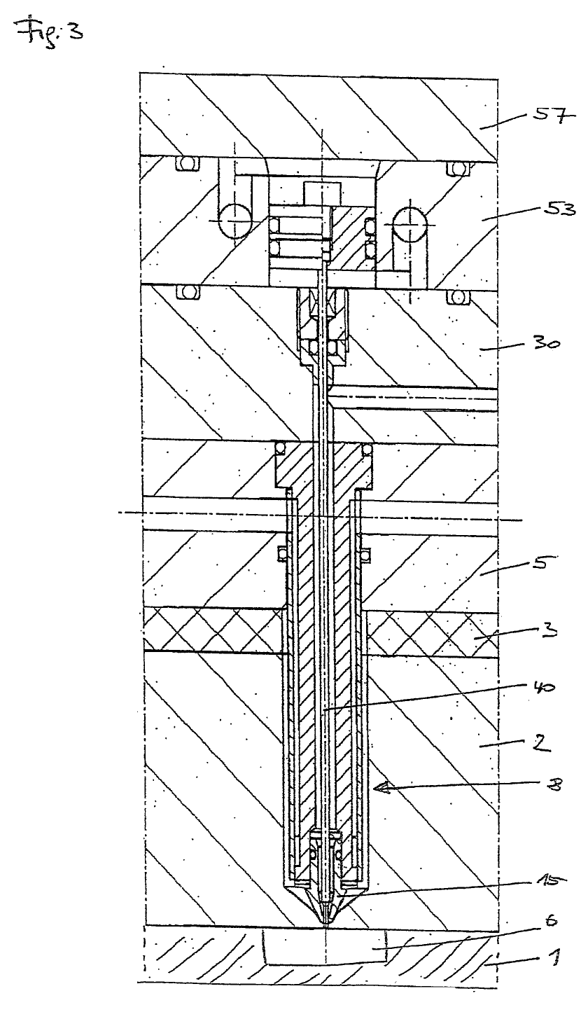

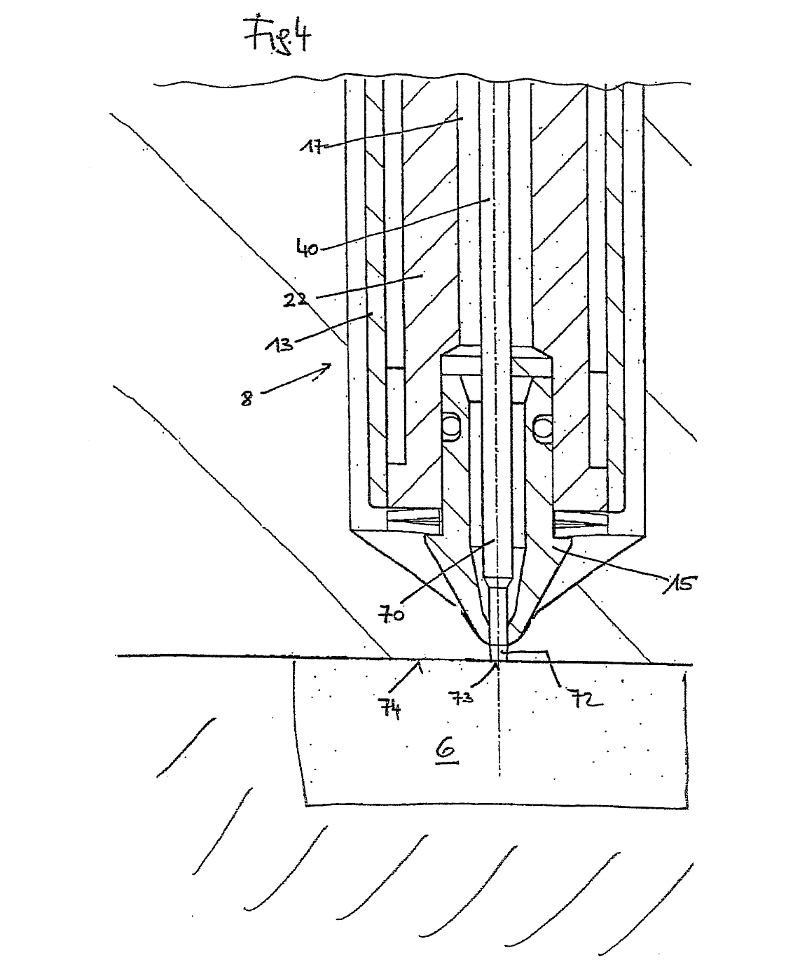

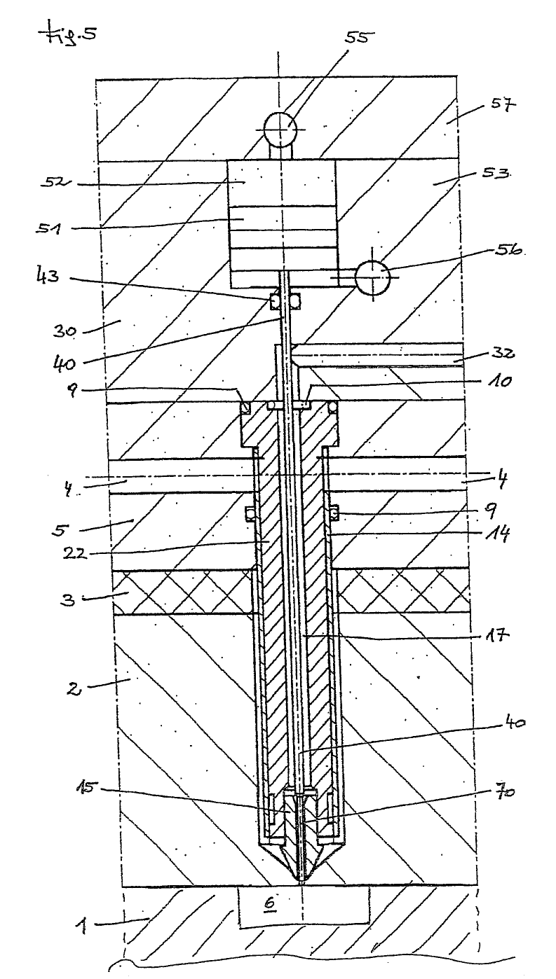

Other details and features and advantages of the needle seal nozzle as claimed in the invention derive from the following description of embodiments of the invention with reference to the drawings. FIG. 1 shows in cross section an injection mold equipped with a needle seal nozzle with the nozzle opened; FIG. 2 shows an enlarged detail to FIG. 1; FIG. 3 shows the injection mold from FIG. 1 with the nozzle closed; FIG. 4 shows an enlarged detail from FIG. 3, and FIG. 5 shows another embodiment of a needle seal nozzle.

An injection mold is formed by two mold plates 1 and 2 which surround and border a mold cavity 6. On the back of the mold plate 2 there is an insulating plate 3. The insulating plate 3 adjoins a temperature control plate 5 in which the needle seal nozzle 8 (injection nozzle) is located.

The injection nozzle 8 projects through the insulating plate 3 and the mold plate 2 as far as the mold cavity 6 and with the nozzle tip 15 adjoins the contact surface 21 in the area of the entry hole 18 for the material which is to be injected into the mold cavity 6. The injection nozzle 8 has a nozzle body 22 over which the sleeve 13 is pushed. The sleeve 13 seals the temperature control channels 14 through which a temperature control liquid flows, with for example 80° C., to the outside. There are temperature control channels 14 in the outside wall of the nozzle body 22. The temperature control channels 14 are connected to holes 4 in the temperature control plate 5, through which holes 4 the temperature control liquid can be delivered and discharged.

To prevent emergence of the temperature control liquid, in the area of the temperature control plate 5 there are two gaskets 9 which seal the injection nozzle 8 and its nozzle body 22 relative to the temperature control plate 5.

The temperature control plate 5 adjoins a material distributor plate 30 in which a channel 32 which is perpendicular to the axis 31 of the injection nozzle 8 in the embodiment is supplied material. The nozzle body 22 is sealed by a gasket 10 relative to the material distributor plate 30.

The nozzle tip 15 is supported to be able to move in the axial direction on the end of the body 22 of the injection nozzle 8 facing the mold cavity 6. To do this, on the nozzle tip 15 there is a cylindrical guide part 23 which is axially movably held in the cylindrical hole 26 in the nozzle body 22. In the cylindrical guide part 23 there is a nozzle cone 24 which forms a transition between an injection hole 17 in the nozzle body 22 and the hole in the nozzle tip 15. In order to prevent emergence of the material to be injected through the gap between the wall of the hole 26 in the nozzle body 22 and the guide part 23 which could occur especially for a thin-liquid material, on the jacket surface of the guide part 23 there is an annular groove in which a gasket 25 is inserted.

Between the end face of the nozzle body 22 and a shoulder on the nozzle tip 15 there is a compression spring, for example a plate spring 7 or a helical spring which continually presses the nozzle tip 15 against the contact surface 21 of the mold plate 2.

In the injection hole 17 of the nozzle body 22 a needle 40 is held to be axially movable. The needle 40 is guided by a seal insert 41 which is inserted in the material distributor plate 30 and is fixed there by a retaining screw 42. In the area of the seal insert 41 there is a gasket ring 43 which adjoins the outside surface of the needle 40.

The end 44 of the needle 40 which projects over the material distributor plate 30 is coupled to a linear motor 50 which in the embodiment shown is made as a piston-cylinder arrangement. Other linear motors, for example, a solenoid actuator, are likewise possible. The piston-cylinder arrangement which is actuated by compressed air (or hydraulically actuated) in the embodiment comprises a piston 51 which is movably guided in the cylinder hole 52 in the cylinder plate 53 in the direction of the axis 31 of the needle 40 and is sealed by two gaskets 54 which are used as piston rings relative to the hole 52 in the cylinder plate 53. In the cylinder plate 53 there are an air connection 55 for supplying the piston 51 from overhead to move the needle 40 into the closed position shown in FIGS. 3 and 4 and another air connection 56 for retracting the needle 40 into the open position shown in FIGS. 1 and 2.

Above the cylinder plate 53 there is a cover plate 57 which is sealed by a gasket 58 relative to the cylinder plate 53 and the cylinder hole 52 is sealed to the top. Analogously the cylinder plate 53 is sealed relative to the material distributor plate 30 by a gasket 59.

On the side of the piston 51 facing away from the needle 40 there is a stop screw 60 which defines the upper setting of the needle 40 by its striking the surface of the cover plate 57 facing in the cylinder plate 53.

The front end of the needle 40 facing the nozzle tip 15 is provided with a neck 70 with a tapered diameter, the transition 71 between the body of the needle 40 and the neck 70 with a tapered diameter being made as a truncated cone. The diameter of the neck 70 of the needle 40 is equal to the inside diameter of the tip hole 16 in the nozzle tip 15. The entry hole 18 in the nozzle plate 2 through which material is injected into the mold cavity 6 is made in the example to taper conically towards the mold cavity 6. Analogously the free end 72 of the neck 70 is likewise made conical on the needle 40 so that in the closed position (FIG. 4) a secure seal of the entry opening 18 is also guaranteed. The conical execution of the end 72 of the needle 40 and the entry hole 18 also ensures that the needle 40 can only be advanced so far that its front end surface 73 is flush with the surface 74 of the mold plate 2 which borders one side of the mold cavity 6.

The free end 72 of the neck 70 can also be cylindrical. In this case the entry opening 18 in the mold plate 2 is also made as a cylinder hole.

The end surface on the end 72 of the neck 70, or, if there is no such neck 70, the front end of the needle 40, can be flat, concave or convex, for example, can have the shape of a partial sphere.

As is often preferred, the front end of the needle 40, or if present, of its neck 70 in the closed position of the needle 40 can project through the entry hole 18 into the mold cavity 6. In this case the needle 40 projects over the surface 74 of the mold cavity 6.

The position of the needle 40 in its advanced position, therefore in the closed position, can also be defined by the fact that on the needle 40 with which optionally made in one piece there is a collar which for example interacts with the nozzle cone 24 in the nozzle tip 15.

The needle 40 of the injection nozzle 8 in the embodiments shown in the area of the injection hole 17 in the nozzle body 22 is not specially guided since it is centered relatively accurately by the material supplied via the gate channel 32 in the material distributor plate 30 and when the needle 40 is moved into its closed position (FIG. 4) by its conical front end 72 on the neck 70 fits reliably into the tip hole 16 or the entry opening 18. Nevertheless, the needle 40 can be guided in the injection hole 17, for example by a for example star-shaped guide body (not shown) which is set via the needle 40.

When the needle 40 of the injection nozzle 8 as claimed in the invention is blocked against turning around its axis 31, therefore is movably guided exclusively in the direction of its axis 31, the front end surface 73 on the neck 70 of the nozzle needle 40 can be shaped such that in the closed position (FIG. 4) it complements the surface 74 of the mold plate 2 which faces the mold cavity 6 and which is interrupted by the mouth of the entry hole 18 in the mold plate 2. This is important for example when the mold cavity 6 is made other than flat at least on its surface facing the mold plate 2. For example, the front end surface 73 of the neck 70 on the nozzle needle 40 can be arched convexly or concavely according to the wall 74 of the mold cavity 6 (the wall formed by the mold plate 2) in which there is an entry hole 18.

In the embodiment of a needle seal nozzle as claimed in the invention shown in FIG. 5 the front end position of the needle 40 is defined by the surface with the shape of the jacket of a truncated cone between the needle 40 and the neck 70 adjoining the nozzle cone 24 of the nozzle tip 15.

FIG. 5 shows that the entry hole 18 of a cylinder hole and the front end 72 of the needle are shaped convexly.

In the embodiment shown in FIG. 5, in place of the seal insert 41, in the material distributor plate 30 for sealing purposes a gasket 43 is inserted into an annular groove.

The hydraulic cylinder of the embodiment from FIG. 5 is supplied with a hydraulic fluid (gas or liquid) via a connecting channel 56 in the cylinder plate 53 and via a connection channel 55 in the cover plate 57.

1. Injection nozzle (8) for polymers which are not crosslinked, but which can be crosslinked, especially gum elastic, rubber and polysiloxanes, characterized by a nozzle tip (15) which in the area of the mold cavity (6) at the entry hole (18) which is located in the mold plate (2) discharges into a mold cavity (6), there is a nozzle needle (40) which can be moved axially by a linear motor (50) in the nozzle (8) and which can be moved out of the closed position which seals the hole (16) in the nozzle tip (15) and into a position in which the end of the needle (40) is located at a distance from the tip hole (10) in the nozzle tip (15), and a temperature control jacket (13, 14) through which a temperature control liquid flows.

2. Nozzle as claimed in claim 1, wherein the nozzle needle (40) can be axially moved by a linear motor (50) which is made as a hydraulic motor.

3. Nozzle as claimed in claim 2, wherein the hydraulic motor (50) is a double-acting piston-cylinder arrangement (51, 52).

4. Nozzle as claimed in one of claims 1 to 3, wherein the nozzle needle (40) on its front end has a neck (70) with a tapered diameter, its outside diameter being equal to the inside diameter of the hole (16) in the nozzle tip (15).

5. Nozzle as claimed in claim 4, wherein the free end (72) of the neck (70) is made conically tapering, for example as a truncated cone.

6. Nozzle as claimed in one of claims 1 to 5, wherein the nozzle needle (40) is guided to be able to move axially relative to the nozzle body (22) and is guided to be unable to turn around its axis (31).

7. Injection mold, especially for curing or vulcanizing elastomer materials, with a mold cavity (6) which is bordered by mold plates (1, 2) and with an injection nozzle (8) as claimed in one of claims 1 to 6, wherein the nozzle needle (40) is guided through a hole in the material distributor plate (30) and wherein the material distributor plate (30) is connected to the mold plate (2) optionally via a temperature control plate (5) and an insulating plate (3).

8. Injection mold as claimed in claim 7, wherein in the material distributor plate (30) there is at least one gate channel (4) which communicates with the injection hole (17) in the injection nozzle (8).

9. Injection mold as claimed in claim 7 or 8, wherein the guide of the needle (40) in the material distributor plate (30) is made as a seal insert (41).

10. Injection mold as claimed in claim 9, wherein the seal insert (41) is fixed in the material distributor plate (30) by the retaining screw (42).

11. Injection mold as claimed in claim 10, wherein the retaining screw (42) loads a gasket (43) which has been inserted in the seal insert (41).

12. Injection mold as claimed in claim 10 or 11, wherein the retaining screw (42) for the seal insert (41) is made in the manner of a screw without a head and is screwed into the threaded hole in the material distributor plate (30).

13. Injection mold as claimed in one of claims 7 to 11, wherein in the area of the adjoining surfaces of the temperature control plate (5) and the material distributor plate (30) there are gaskets (9) which surround the injection nozzle (8).

14. Injection mold as claimed in one of claims 7 to 13, wherein the linear motor (50) for actuating the needle (40) is a piston (51) which is movably guided in the cylinder hole (52) in the cylinder plate (53) and which is connected to the needle (40).

15. Injection mold as claimed in claim 14, wherein in the cylinder plate there are hydraulic fluid connections (55, 56) via which the piston (50) can be exposed to hydraulic fluid to move the needle (40).

16. Injection mold as claimed in claim 14 or 15, wherein the cylinder hole (52) in the cylinder plate (53) is seated on the side facing away from the needle (40) by a cover plate (57).

17. Injection mold as claimed in claim 16, wherein on the piston (51) there is a stop screw (60) which when the needle (40) is in its open position adjoins the side of the cover plate (60) facing the cylinder hole (52).

18. Injection mold as claimed in one of claims 7 to 17, wherein the entry hole (18) into the mold cavity (6) is made congruent to the free end (72) of the neck (70) on the nozzle needle (40).

19. Injection mold as claimed in claim 18, wherein the entry hole (18) which is provided in the one mold plate (2) and via which material can be injected from the injection nozzle (8) into the mold cavity (6) is made conically tapering toward the mold cavity (6), and wherein the conicity of the entry hole (18) is equal to the conical free end (72) on the neck (70) of the needle (40).

20. Injection mold as claimed in one of claims 7 to 19, wherein the front end surface (73) of the needle (40), especially the end face (73) of the neck (70) of the needle (40) when the needle is in the closed position is flush with the surface of the mold plate (2) facing the mold cavity (6).

21. Injection mold as claimed in one of claims 7 to 20, wherein the nozzle needle (40) is guided not to be able to turn in the injection nozzle (8) and wherein the free end surface (73) of the needle (40) in its closed position complements the surface (74) of the mold cavity (6) in which the entry hole (18) is located.

22. Injection mold as claimed in claim 21, wherein the end surface (73) of the surface (74) is shaped accordingly.
